(19) United States
(12) Patent Application Publication
(10) Pub. No.: US 2006/0138694 A1
(43) Pub. Date: Jun. 29, 2006

(54) Method of making a polymeric film having structured surfaces via replication

(76) Inventors: Rolf W. Biernath, Wyoming, MN (US); Daniel W. Hennen, Cottage Grove, MN (US); William B. Black, Eagan, MN (US); Olester Benson JR., Woodbury, MN (US); William Ward Merrill, White Bear Lake, MN (US); Andrew J. Ouderkirk, Woodbury, MN (US); Robert L. Brott, Woodbury, MN (US); John S. Huizinga, Dellwood, MN (US)

Correspondence Address: 3M INNOVATIVE PROPERTIES COMPANY, PO BOX 33427, ST. PAUL, MN, 55133-3427, US

(21) Appl. No.: 11/184,023

(22) Filed: Dec. 23, 2004

(51) Int. Cl. B29C 69/00

(52) U.S. Cl. 264/210.2; 264/284; 264/288.4

(57) ABSTRACT

Method of Making a Polymeric Film Having Structured Surfaces Via Replication A method of making a polymeric film via a replication process is disclosed. The process provides a tool that has a negative version of a desired structured surface; contacting the negative surface of the tool to a polymeric material to form the desired surface in the polymeric material; removing the polymeric material having the desired structured surface from the tool; and uniaxially stretching the polymeric material.

### FIELD

The present invention relates to uniaxially stretched articles, such as polymeric films, having structured surfaces, and to processes for making such articles. The structured surfaces comprise at least one geometric feature that has a desired cross section.

### BACKGROUND

Optical articles having structured surfaces, and processes for providing such articles are known. See for example, U.S. Pat. Nos. 6,096,247 and 6,808,658, and published application U.S. 2002/0154406 A1. The structured surfaces disclosed in these references include microprisms (such as microcubes) and lenses. Typically these structures are created on the surface of a suitable polymer by, for example embossing, extrusion or machining.

Birefringent articles having structured surfaces are also known. See, for example, U.S. Pat. Nos. 3,213,753; 4,446,305; 4,520,189; 4,521,588; 4,525,413; 4,799,131; 5,056,030; 5,175,030 and published applications WO 2003/0058383 A1 and WO 2004/062904 A1.

Processes for manufacturing stretched films are also known. Such processes are typically employed to improve the mechanical and physical properties of the film. These processes include biaxial stretching techniques and uniaxial stretching techniques. See for example PCT WO 00/29197, U.S. Pat. Nos. 2,618,012; 2,988,772; 3,502,766; 3,807,004; 3,890,421; 4,330,499; 4,434,128; 4,349,500; 4,525,317 and 4,853,602. See also U.S. Pat. Nos. 4,862,564; 5,826,314; 5,882,774; 5,962,114 and 5,965,247. See also Japanese Unexamined Patent Publications Hei 5-11114; 5-288931; 5-288932; 6-27321 and 6-34815. Still other Japanese Unexamined Applications that disclose processes for stretching films include Hei 5-241021; 6-51116; 6-51119; and 5-11113. See also WO 2002/096622 A1.

### SUMMARY

The present invention provides a film having a structured surface, articles made therefrom, and a novel process for the manufacture thereof. The structured surface comprises at least one geometric feature having a desired cross-sectional shape. One embodiment of the article of the invention comprises a film having the structured surface. One aspect of the invention comprises an article that has a uniaxial orientation, preferably a truly uniaxial orientation throughout its thickness. The structured surface may comprise a plurality of geometric features. The geometric feature or features may be elongate. The feature or features are substantially aligned with a first in-plane axis of the article. The article of the invention comprises a land, or body, portion having a structured surface thereon. The article may comprise a single layer or a plurality of separate layers. The article of the invention may have a structured surface on opposing sides thereof. The layers may comprise different polymeric materials. The article may be positively or negatively birefringent.

One embodiment of the article of the invention comprises a uniaxially oriented structured surface polymeric film comprising:
(a) a polymeric body having (i) a first and a second surface, and (ii) first and second in-plane axes that are orthogonal with respect to each other and a third axis that is mutually orthogonal to the first and second in-plane axis in a thickness direction of the polymeric film; and
(b) a linear geometric feature disposed on the first surface of the polymeric body in a direction substantially parallel to the first in-plane axis of the polymeric film;
   wherein the film has a shape retention parameter (SRP) of at least 0.1.

Another embodiment of the invention comprises a uniaxially oriented film comprising:
(a) a polymeric body having (i) a first and a second surface, and (ii) first and second in-plane axes that are orthogonal with respect to each other and a third axis that is mutually orthogonal to the first and second in-plane axis in a thickness direction of the polymeric film; and
(b) a linear geometric feature disposed on the first surface of the polymeric body
in a direction substantially parallel to the first in-plane axis of the polymeric film; wherein the polymeric film has a stretch ratio of at least 1.5 in the direction of the first in-plane axis, and wherein the ratio of the larger to the smaller of the stretch ratios along the second in-plane axis and the third axis is 1.4 or less, and wherein the film has substantially the same uniaxial orientation throughout the thickness of the body and the geometric feature.

Still another embodiment of the article of the invention comprises a uniaxially oriented structured surface polymeric film comprising:
(a) a polymeric body having (i) a first and a second surface, and (ii) first and second in-plane axes that are orthogonal with respect to each other and a third axis that is mutually orthogonal to the first and second in-plane axis in a thickness direction of the polymeric film; and
(b) a linear geometric feature disposed on the first surface of the polymeric body in a direction substantially parallel to the first in-plane axis of the polymeric film;
   wherein the (a) ratio of the thickness of the body (Z′) to the height of the geometric feature (P′) is at least about 2; or (b) the ratio of body thickness to feature height (Z′:P′) is at least about 1 and the ratio of feature height to a feature separation (P′:FS′) is at least about 1; or (c) the ratio of body thickness to feature height (Z′:P′) is at least about 1 and the ratio of feature base width to a feature separation (BW′:FS′) is at least about 1; or (d) the ratio of body thickness to feature base width (Z′:BW′) is at least about 3; or (e) the ratio of body thickness to feature base width (Z′:BW′) is at least about 1 and the ratio of feature height to a feature separation (P′:FS′) is at least about 1; or (f) the ratio of body thickness to feature base width (Z′:BW′) is at least about 1 and the ratio of feature base width to a feature separation (BW′:FS′) is at least about 1; or (g) the ratio of feature base width to feature top width (BW′:TW′) is at least about 2 and the ratio of feature base width to a feature separation (BW′:FS′) is at least about 1.

In still another embodiment of the invention, the article of the invention, substantially as described above, has a ratio of the thickness of the body to the width of the base of the feature of at least about 3.

Yet another embodiment of the article of the invention comprises a uniaxially oriented structured surface polymeric film comprising:
(a) a polymeric body having (i) a first and a second surface, and (ii) first and second in-plane axes that are orthogonal with respect to each other and a third axis that is mutually orthogonal to the first and second in-plane axis in a thickness direction of the polymeric film; and
(b) a linear geometric feature disposed on the first surface of the polymeric body in a direction substantially parallel to the first in-plane axis of the polymeric film;
   wherein the oriented polymeric film has (i) a first index of refraction (n₁) along the first in-plane axis, (ii) a second index of refraction (n₂) along the second in-plane axis, and (iii) a third index of refraction (n₃) along the third axis, wherein nl : n₂ and n≠n₃ and n₂ and n₃ are substantially equal to one another relative to their differences with n₁. In one aspect of this embodiment of the invention the ratio of the thickness of the polymeric body to the height of the geometric feature is at least about 2.

The present invention also provides a roll of uniaxially oriented structured surface article comprising:
(a) a polymeric body having (i) a first and a second surface, and (ii) first and second in-plane axes that are orthogonal with respect to each other and a third axis that is mutually orthogonal to the first and second in-plane axis in a thickness direction of the polymeric film; and
(b) a surface portion comprising a linear geometric feature disposed on the on the first surface of the polymeric body, the linear geometric feature being disposed on the body in a direction substantially parallel to the first in-plane axis of the polymeric film.

In another aspect of the invention, the roll as described above comprises a polymeric film that is uniaxially oriented along the first in-plane axis. In yet another aspect, the roll as described above further comprises a cushioning layer between individual wraps of the roll. The cushioning layer aids in protecting the structured surface from damage and/or distortion during manufacture, storage and shipping.

In the present invention, the geometric feature may be either a prismatic or lenticular geometric feature. The geometric feature may be continuous or discontinuous along the first in-plane axis. It may be a macro- or a micro-feature. It may have a variety of cross-sectional profiles as discussed more fully below. The geometric feature may be repeating or non-repeating on the structured surface. That is, the structured surface may comprise a plurality of geometric features that have the same cross-sectional shape. Alternatively, it may have a plurality of geometric features that have different cross-sectional shapes. In another embodiment, the structured surface may comprise a predetermined pattern of countable features that may be arranged in either a periodic or a non-periodic manner.

In yet another aspect of the invention, the article has a first refractive index (n₁) along the first in-plane axis, a second refractive index (n₂) along the second in-plane axis and a third refractive index (n₃) along the third in-plane axis. In the present invention, n₁≠to each of n₂ and n₃. That is, n₁ may be greater than n₂ and n₃ or it may be less than n₂ and n₃. Preferably n₂ and n₃ are substantially equal to one another. The relative birefringence of the film of the invention is preferably 0.3 or less.

The present invention may also comprise a multi-phase film. In this embodiment, the film may comprise a multi-component phase separating system or one in which one component is dissolved in another to create either a porous structure or very small particles in a continuous matrix or a bi-continuous matrix.

The present invention may also incorporate an additional layer over either the microstructured surface or the second surface. It may also incorporate additional layers on either or both of such surfaces. The additional layer can be added before or after stretching. If the additional layer is added before stretching, it should be capable of being stretched. Examples of such layers include, but are not limited to, antireflective layers, index-matching layers and protective layers.

Truly uniaxial stretching is particularly useful when an additional layer is employed. In this case, for example, stress build-up in the cross direction is minimized so that factors of adhesion between the layers is a less critical feature.

In another aspect, the present invention comprises a roll of microstructure film with predetermined properties defined in reference to a coordinate system of first and second orthogonal in-plane axes and a third mutually orthogonal axis in a thickness direction of the film. For example, the geometric features can be aligned with the direction of wrap of the roll (i.e., along the machine direction (MD)) or they may be aligned transverse to the direction of wrap of the roll (i.e., along the cross direction (TD)). Alternatively, the geometric structures may be aligned at any desired angle to the MD or TD directions.

The present invention further comprises a method of making a structured surface film. One aspect, the method of the invention comprises the steps of:
(a) providing a polymeric film having (i) a first surface comprising a desired geometric feature; and a second surface, and (ii) first and second in-plane axes that are orthogonal with respect to each other and a third axis that is mutually orthogonal to the first and second in-plane axis in a thickness direction of the polymeric film and subsequently
(b) stretching the polymeric film in a direction substantially parallel to the first in-plane axis of the polymeric film;
   wherein the cross sectional shape of the geometric feature before step (b) is substantially retained after step (b).

In another aspect, the invention comprises a method of making a structured surface film that comprises the steps of:
(a) providing a polymeric film having (i) a first structured surface and a second surface, and (ii) first and second in-plane axes that are orthogonal with respect to each other and a third axis that is mutually orthogonal to the first and second in-plane axis in a thickness direction of the polymeric film, wherein the first structured surface has a geometric feature disposed thereon in a direction substantially parallel to the first in-plane axis; and subsequently
(b) uniaxially orienting the polymeric film in a direction substantially parallel to the first in-plane axis of the polymeric film.

Yet another aspect the invention comprises a method of making a structured surface film that comprises the steps of:
(a) providing a tool that comprises a negative of a desired structured surface;
(b) contacting the tool with a resin to create the desired surface, the desired structure surface comprising a geometric feature;
(c) optionally, solidifying the resin to form a film having (i) the desired structured surface and an opposed surface, and (ii) first and second in-plane axes that are orthogonal with respect to each other and a third axis that is mutually orthogonal to the first and second in-plane axis in a thickness direction of the film;
(d) removing the film from the tool; and subsequently
(e) stretching the polymeric film in a direction substantially parallel to the first in-plane axis of the polymeric film.

Another embodiment of the invention comprises a method of making a desired microstructure surface film having a plurality of elongate geometric micro-features. The method comprising the steps of:
(a) providing a tool comprising a negative version of the desired microstructure surface;
(b) providing a molten polymeric resin to a gap formed between the master tool and a second surface;
(c) forming a polymeric film having the desired microstructure surface in the gap, the film having (i) first and second in-plane axes that are mutually orthogonal with respect to each other and a third axes that is mutually orthogonal with respect to the first and second in-plane axes in a thickness direction of the film, and (ii) the desired microstructure surface having the elongate micro-features positioned in a direction substantially parallel to the first in-plane axis;
(d) removing the polymeric film of step (c) from the tool; and
(e) stretching the polymeric film in a direction substantially parallel to the first in-plane axis.

In one embodiment of the method(s) of the invention, the article has a first orientation state prior to stretching and a second orientation state, different from the first orientation state, after stretching. In another embodiment, stretching provides a smaller, physical cross section (i.e., smaller geometric features) without substantial orientation.

The method(s) of the invention provide a polymeric film that is birefringent after stretching, and has a first index of refraction (n₁) along the first in-plane axis, a second index of refraction (n₂) along the second in-plane axis, and a third index of refraction (n₃) along the third axis.

In another embodiment of the invention, the method creates substantially the same proportional dimensional changes in the direction of both of the second and third in-plane axes of the film. These proportional dimensional changes in the direction of the second and third in-plane axes are substantially the same throughout the stretch or stretch history of the film.

In another aspect of the invention, the film as manufactured by any method of the invention is fibrillated after stretching to provide one or more uniaxially oriented fibers having a structured surface. The fibers may be created as individual fibers or as two or more fibers joined along their length to one another.

As used herein, the following terms and phrases have the following meaning.

“Cross sectional shape”, and obvious variations thereof, means the configuration of the periphery of the geometric feature defined by the second in-plane axis and the third axis. The cross sectional shape of the geometric feature is independent of is physical dimension and presence of defects or irregularities in the feature.

“Stretch ratio”, and obvious variations thereof, means the ratio of the distance between two points separated along a direction of stretch after stretching to the distance between the corresponding points prior to stretching.

“Geometric feature”, and obvious variations thereof, means the predetermined shape or shapes present on the structured surface.

“Macro” is used as a prefix and means that the term that it modifies has a cross-sectional profile that has a height of at least 1 mm.

“Micro” is used as a prefix and meant that the term that if modifies cross-sectional profile that has a height of 1 mm or less. Preferably the cross-sectional profile has a height of 0.5 mm or less. More preferably the cross-sectional profile has a height of 0.05 mm or less.

“Uniaxial stretch”, including obvious variations thereof, means the act of grasping opposite edges of an article and physically stretching the article in only one direction. Uniaxial stretch is intended to include slight imperfections in uniform stretching of the film due to, for example, shear effects that can induce momentary or relatively very small biaxial stretching in portions of the film.

“Structure surface” means a surface that has at least one geometric feature thereon.

“Structured surface” means a surface that has been created by any technique that imparts a desired geometric feature or plurality of geometric features to a surface.

“True uniaxial orientation”, and obvious variations thereof, means a state of uniaxial orientation (see below) in which the orientation sensitive properties measured along the second in-plane axis and the third axis are substantially equal and differ substantially from the orientation sensitive properties along the first in-plane axis.

Real physical systems generally do not have properties which are precisely and exactly identical along the second in-plane axis and the third axis. The term “true uniaxial orientation” is used herein to refer to a state of orientation in which orientation-sensitive properties of the film measured along these axes differ only by a minor amount. It will be understood that the permissible amount of variation will vary with the intended application. Often, the uniformity of such films is more important than the precise degree of uniaxial orientation. This situation is sometimes referred to in the art as “fiber symmetry”, because it can result when a long, thin, cylindrical fiber is stretched along its fiber axis.

“True uniaxial stretch” and obvious variations thereof, means the act of providing uniaxial stretch (see above) in such a manner that the stretch ratios along the second in-plane axis and the third axis are substantially identical to each other but substantially different from the stretch ratio along the first in-plane axis.

“Uniaxial orientation”, including obvious variations thereof, means that an article has a state of orientation in which orientation sensitive properties of the article measured along the first in-plane axis, i.e., the axis substantially parallel to the uniaxial stretching direction, differ from those measured along the second in-plane axis and the third axis. Though a wide variety of properties may be measured to determine the presence of uniaxial orientation, refractive index is the property of interest herein unless another is specified. Other illustrative examples of such properties include the crystal orientation and morphology, thermal and hygroscopic expansions, the small strain anisotropic mechanical compliances, tear resistance, creep resistance, shrinkage, the refractive indices and absorption coefficients at various wavelengths.

In the case of layered films, “uniaxial” or ” truly uniaxial” are intended to apply to individual layers of the film unless otherwise specified.

### BRIEF DESCRIPTION OF THE DRAWINGS

The invention may be more completely understood in the following detailed description of various embodiments of the invention in connection with the accompanying drawings, in which:

FIG. 1 is a sectional view of a precursor film useful in the present invention;

FIG. 2 is a sectional view of one embodiment film of the present invention;

FIGS. 3A-3D are sectional views of some alternative embodiments of the film of the present invention;

FIGS. 4A-4D are illustrations useful in determining how to calculate the shape retention parameter (SRP);

FIGS. 5A-5W illustrate sectional views of some alternative profiles of geometric features useful in the present invention;

FIG. 6 is a schematic representation of a process according to the present invention;

FIG. 7 is a perspective view of a structure surface film both before and after the stretching process, wherein the film after stretching is uniaxially oriented;

FIG. 8 is a schematic illustration of a method for uniaxially stretching a film according to the present invention also illustrating a coordinate axis showing a machine direction (MD), a normal, i.e., thickness, direction (ND), a transverse direction (TD).

FIG. 9 is an end view of an article of the invention having a structured surface of varying cross-sectional dimensions.

The invention is amenable to various modifications and alternative forms. Specifics of the invention are shown in the drawings by way of example only. The intention is not to limit the invention to the particular embodiments described. Instead, the intention is to cover all modifications, equivalents, and alternatives falling within the spirit and scope of the invention.

### DETAILED DESCRIPTION

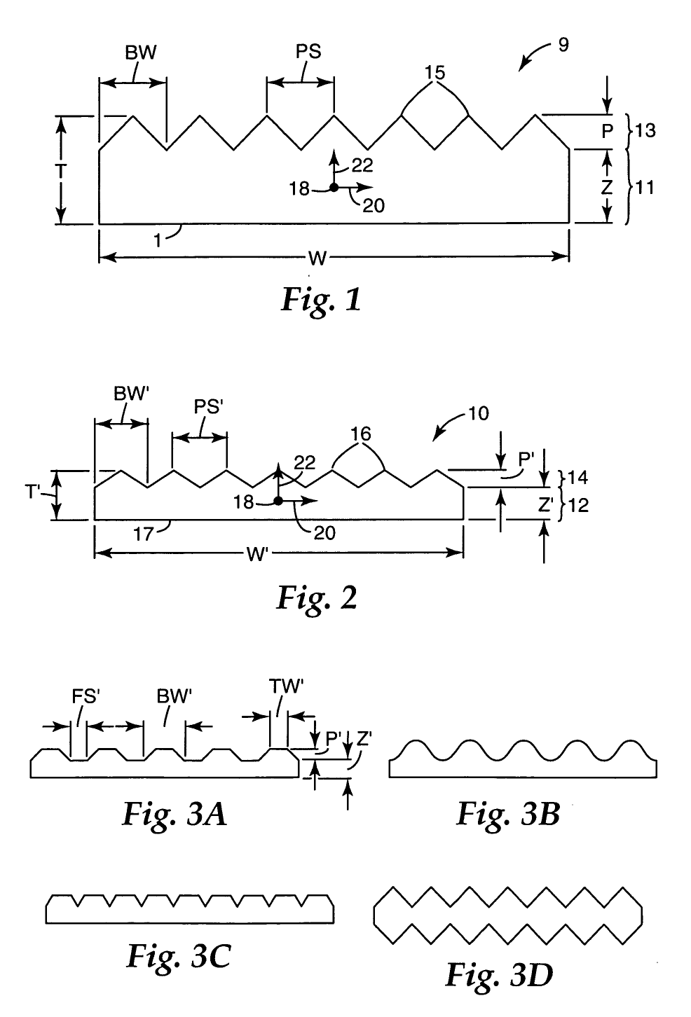

The articles and films of the invention generally comprise a body portion and a surface structure portion. FIG. 1 represents an end view of a pre-cursor film having a first orientation state while FIG. 2 represents an end view of one embodiment of the film of the invention having a second orientation state FIGS. 3A-3D represent end views of some alternative embodiments of the invention.

Precursor film 9 comprises a body or land portion 11 having an initial thickness (Z) and a surface portion 13 having a height (P). Surface portions 13 comprises a series of parallel geometric features 15 here shown as right angle prisms. Geometric features 15 each have a base width (BW) and a peak-to-peak spacing (PS). The precursor film has a total thickness T which is equal to the sum of P+Z.

With specific reference to FIG. 2, the film of the invention 10 comprises a body or land portion 12 having a thickness (Z′) and a surface portion 14 having a height (P′). Surface portion 14 comprises a series of parallel geometric features 16 comprising prisms. Geometric features 16 each have a base width (BW′) and a peak-to-peak spacing (PS′). The film of the invention has a total thickness T′ which is equal to P′+Z′.

The relationship between the dimensions of the precursor film and the film of the invention are T′<T; P′<P; Z′<Z; usually BW′<BW; and PS′<PS.

Body or land portions 11, 12 comprise the portion of the article between bottom surfaces 17 and 19 and the lowest point of the surface portions 15, 16. In some cases, this may be a constant dimension across the width (W,W′) of the article. In other cases, this dimension may vary due to the presence of geometric features having varying land thicknesses. See FIG. 9. In FIG. 9, the land thickness is represented by Z″.

The precursor film 9 and the film of the invention 10 each have a first in-plane axis 18, a second in-plane axis 20 and a third axis 22 in the thickness direction. The first in-plane axis is substantially parallel to the direction of stretching as discussed herein after. In FIGS. 1 and 2, this axis is normal to the end of films 9 and 10. These three axes are mutually orthogonal with respect to one another.

The cross-sectional shape of at least one geometric feature of the film or article of the present invention substantially mimics the cross-sectional shape of the geometric feature of its precursor. This fidelity in shape is especially important when making optical devices where uniform redistribution of incident light is desired. This is true whether the initial cross-sectional shape of the feature comprises flat or curved surfaces. The shape retention of the article and process is determined by calculating the Shape Retention Parameter (SRP).

SRP for a given feature is determine as follows. An image is acquired of a cross-section of a film having the feature before stretching. The sectioning plane is the plane defined by the second in-plane axis 20 and the third axis 22 and is orthogonal to the direction in which the film is to be stretched. One representative example of the structural features present is chosen, and is referred to as the feature. A line is superimposed on the image at the junction of the body portion 11 and the surface portion 13. This is the Feature Baseline (FB). The area of the feature above its baseline is then calculated. This is the Unstretched Feature Area (UFA).

An image is then acquired of a cross-section of the film after stretching. The sectioning plane is the plane defined by the second in-plane axis and the third axis. If the film has been stretched by a non-continuous, or “batch” process, such as on a laboratory film stretching instrument, it will be possible to select the same feature as that selected when examining the film specimen before stretching. If the film has been stretched on a continuous film-making line, the feature should be selected from an appropriate location on the stretched film web, analogous to the location that was chosen on the unstretched web, as will be appreciated by one skilled in the film making art. A Feature Baseline (FB) is again established, and the area of the stretched film feature is then calculated. This is the Stretched Feature Area (SFA).

The ratio UFA/SFA is then calculated. This is the Image Ratio (IR). The image of the stretched film feature is then scaled up proportionately so as to have the same area as the image of the unstretched film feature. This is done by expanding the image in each of the height and width dimensions by a factor of the square root of IR. The scaled up image of the feature of the stretched film is then superimposed on the image of the feature of the unstretched film in such a way that their Feature Baselines coincide. The superimposed images are then translated with respect to one another along their common baseline, until the location is found that maximizes the area of their overlap. This and all the aforementioned and subsequent mathematical and numerical operations can be done simply on a computer with appropriately written code, as will be apparent to one skilled in the art.

The area shared by both of the superimposed images in this optimally superimposed condition is the Common Area (CA). The ratio CA/UFA is then calculated. This ratio is the Common Area Ratio (CAR). For a stretch that results in perfect shape retention, the CAR will be unity. For any deviation from perfect shape retention, the CAR will be a positive number less than unity.

For any particular film, CAR will differ from unity by an amount that depends at least on the shape of the feature, the stretch ratio, and the degree to which the stretching operation approaches a truly uniaxially orienting stretch. Other factors may also be involved. In order to quantify the degree of deviation from perfect shape retention, it is necessary to develop another parameter, the Shape Retention Parameter (SRP). The SRP is a measure which indicates proportionately where a film having a structured surface falls, on a continuum, from perfect shape retention at one extreme, to a selected reference point characteristic of typical industrial practice, at the other extreme. We have chosen as such a reference point the performance, for the same feature shape and stretch ratio, of an idealized film tenter (transverse orienter) operated efficiently in a continuous mode. The major axis of the features on the film's structured surface is assumed to be parallel to the crossweb direction, which is the stretch direction. Edge effects and all other process non-idealities are neglected, as are non-idealities of the film material itself, such as changes in density upon stretching, for example. For this ideal tenter case, then, all the transverse stretch imparted to the film is accommodated by shrinkage of the film, by the same ratio, and in the thickness dimension only. Because the hypothetical tenter is ideal, there is no shrinkage of the film in the machine or downweb direction.

Image Ratio, for a film that stretches ideally, is the same as the stretch ratio. If the Image Ratio is different from the stretch ratio, this is indicative of non-idealities in the system due to, for example, Poisson's Ratio, density changes (e.g., due to crystallization during stretch) and variations between the local stretch ratio and the nominal ideal stretch ratio.

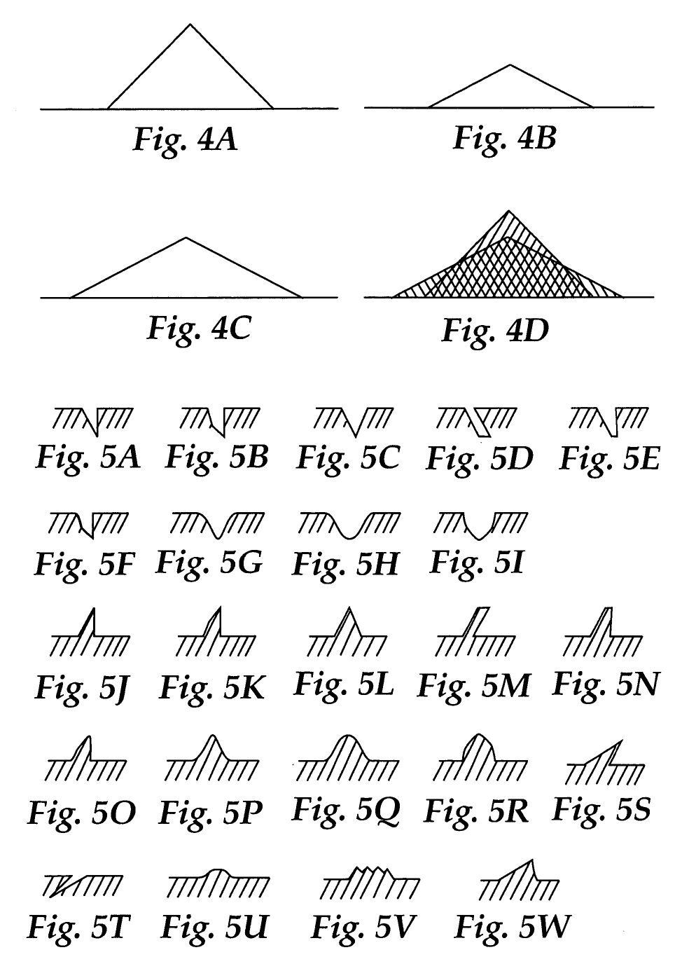

The following will be described with reference to FIG. 4A-4D. The calculations may easily be performed by computer using algorithms know to those skilled in the art. The calculation begins with the experimentally obtained image of the feature of the unstretched film which was used already to calculate the CAR. In FIG. 4A, the feature shown is a right triangle feature. The right triangle is shown in FIG. 4A only for illustrative purposes as the methodology detailed here is generally applicable to any feature shape, whether having or not having symmetry, and whether having straight (prismatic) or curved (lenticular) surfaces. The methodology is also generally applicable to “dished” features, or features having complex shapes, such as S-shaped features, hook-shaped features, or “mushroom-cap” features.

The image of FIG. 4A is computationally converted to the image of FIG. 4B by shrinking only the height dimension by a factor of the stretch ratio used in making the film in question. This simulates what would have happened to the film surface feature in the “ideal tenter” for the feature shape and stretch ratio in question. The image is then converted from that of FIG. 4B to that of FIG. 4C by scaling it up in each of the height and width dimensions by a factor of the square root of the stretch ratio. Thus, the image of FIG. 4C has an area identical to that of the image of FIG. 4A. The images of FIG. 4A and FIG. 4C are then superimposed and translated along their common baseline until the position of maximum overlap area is found. This is shown in FIG. 4D. The common area of this figure (the crosshatched area which is common to both the original feature image and the computationally processed feature image) is calculated, and the ratio of this area to the area of the image of FIG. 4A is calculated. This value is the Common Area Ratio for the Ideal Tenter (CARIT), for the given feature shape and stretch ratio. It will be understood that this calculation must be done independently for each film specimen, as the CARIT is a strong function of both the unstretched feature shape and the stretch ratio employed.

Finally, SRP is calculated using the following formula:
SRP=(CAR-CARIT)/(1-CARIT)
For perfect shape retention, SRP is unity. For the case of a hypothetical film stretched on an “ideal” tenter, CAR equals CARIT, and SRP is zero. Thus, SRP is a measure which indicates proportionately where a film having a structured surface falls, on a continuum, from perfect shape retention at one extreme, to a selected reference point characteristic of typical industrial practice, at the other extreme. Films having SRP very close to 1.00 show a very high degree of shape retention. Films having SRP very close to 0.00 show a low degree of shape retention for the feature shape and stretch ratio employed. In the present invention, the films have an SRP of at least 0.1.

It will be understood by one skilled in the art that a film made on a standard film tenter or by other means may well have an SRP value which is less than zero, due to the many non-idealities which are possible, as discussed above. The “ideal tenter” is not meant to represent the worst possible shape retention which can result. Rather, it is a point of reference useful for comparing different films on a common scale.

In one embodiment of the present invention, a film having a structured surface has a value of SRP of about 0.1 to 1.00. In another embodiment of the present invention, a film having a structured surface has a value of SRP of about 0.5 to 1.00. In another embodiment of the present invention, a film having a structured surface has a value of SRP of about 0.7 to 1.00. In another embodiment of the present invention, a film having a structured surface has a value of SRP of about 0.9 to 1.00.

In another aspect of the invention, the film possesses uniaxial orientation. The uniaxial orientation may be measured by determining the difference in the index of refraction of the film along the first in-plane axis (n₁), the index of refraction along the second in-plane axis (n₂), and the index of refraction along the third axis (n₃). Uniaxially oriented films of the invention have n₁≠n₂ and n₁≠n₃. Preferably the films of the invention are truly uniaxially oriented. That is, n₂ and n₃ are substantially equal to one another and relative to their differences with n₁.

In yet another embodiment of the invention the films posses a relative birefringence of 0.3 or less. In another embodiment, the relative birefringence is less than 0.2 and in yet another embodiment it is less than 0.1. Relative birefringence is an absolute value determined according to the following formula:
|n₂−n₃|/|n₁−(n₂+n₃)/2|

Relative birefringence may be measured in either the visible or the near infra-red spectra. For any given measurement, the same wavelength should be used. A relative birefringence of 0.3 in any portion of either spectra is satisfactory to meet this test.

The films of the invention comprises at least one prismatic or lenticular feature that may be an elongate structure. The structure is preferably generally parallel to the first in-plane axis of the film. As shown in FIG. 2, the structured surface comprises a series of prisms 16. However, other geometric features and combinations thereof may be used. For example, FIG. 3A shows that the geometric features do not have to have apices nor do they need to touch each other at their bases.

FIG. 3B shows that the geometric features may have rounded peaks and curved facets. FIG. 3C shows that the peaks of the geometric features may be flat.

FIG. 3D shows that both opposing surfaces of the film may have a structured surface.

FIGS. 5A-5W illustrate other cross-section shapes that may be used to provide the structured surface. These Figures further illustrate that the geometric feature may comprise a depression (See FIGS. 5A-I and 5T) or a projection (see FIGS. 5J-5S and 5U-5W). In the case of features that comprise depressions, the elevated area between depressions may be considered to be a projection-type feature as shown in FIG. 3C.

Various feature embodiments may be combined in any manner so as to achieve a desired result. For example horizontal surfaces may separate features that have radiused or flat peaks. Moreover curved faces may be used on any of these features.

As can be seen from the Figures, the features may have any desired geometric shape. They may be symmetric or asymmetric with respect to the z-axis of the film. Moreover, the structured surface may comprise a single feature, a plurality of the same feature in a desired pattern, or a combination of two or more features arranged in a desired pattern. Additionally, the dimensions, such as height and/or width, of the features may be the same across the structured surface. Alternatively, they may vary from feature to feature.

The microstructure geometric features illustrated in FIG. 2 either comprise or approximate a right angle prism. As used herein, a right prism has an apex angle of from about 70° to about 120°, preferably from about 80° to 100°, most preferably about 90°. Additionally the faces of the microstructure feature are flat or approximate a flat surface.

In another embodiment, the microstructure geometric features comprise a saw tooth-like prism. As used herein a saw tooth-like prism has a vertical, or nearly vertical side that forms an approximately 90° angle with the land or body. See FIG. 5J. In one useful embodiment, a saw-tooth-like prism may have has an angle of inclination from the land or body of from 2° to 15°.

It is also within the scope of the present invention that the features may be either continuous or discontinuous along the first in-plane axis.

Various embodiments of the film of the invention comprise the following dimensional relationships as set forth in FIGS. 2 and 3A:

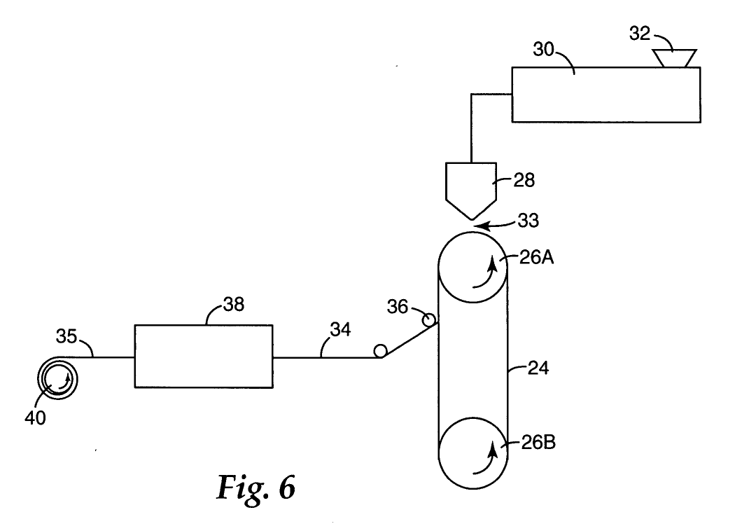

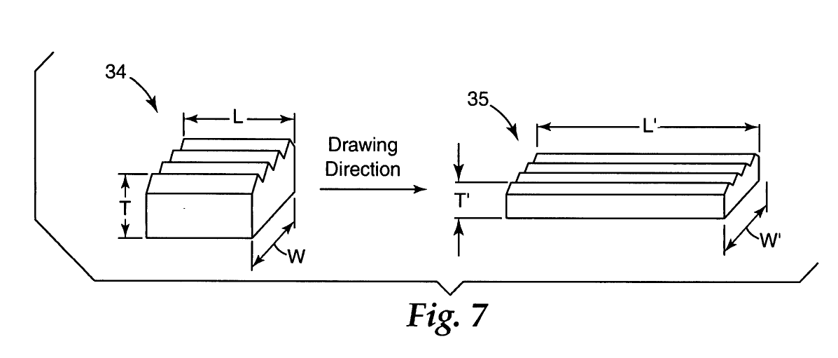

A process of the invention generally comprises the steps of providing a structured surface polymeric film that is capable of being elongated by stretching and subsequently uniaxially stretching the film. The structured surface may either be provided concurrently with the formation of the film or it may be imparted to the first surface after the film has been formed. The process will be further explained with regard to FIGS. 6 and 7.

FIG. 6 is a schematic representation of a method according to the present invention. In the method, a tool 24 comprising a negative version of the desired structured surface of the film is provided and is advanced by means of drive rolls 26A and 26B past an orifice (not shown) of die 28. Die 28 comprises the discharge point of a melt train, here comprising an extruder 30 having a feed hopper 32 for receiving dry polymeric resin in the form of pellets, powder, etc. Molten resin exits die 28 onto tool 24. A gap 33 is provided between die 28 and tool 24. The molten resin contacts the tool 24 and hardens to form a polymeric film 34. The leading edge of the film 24 is then stripped from the tool 24 at stripper roll 36 and is directed to uniaxial stretching apparatus 38. The stretched film may then be wound into a continuous roll at station 40.

It should be noted that film 34 may be wound into a roll, or cut into sheets and stacked before being stretched in apparatus 38. It should also be noted that film 34 may be cut into sheets after being stretched rather than being wound into a continuous roll.

The film 34 may optionally be pre-conditioned (not shown) before the uniaxial stretching. Additionally, the film 34 may be post-conditioned (not shown) after stretching.

A variety of techniques may be used to impart a structured surface to the film. These include batch and continuous techniques. They may involve providing a tool having a surface that is a negative of the desired structured surface; contacting at least one surface of the polymeric film to the tool for a time and under conditions sufficient to create a positive version of the desired structured surface to the polymeric film; and removing the polymeric film with the structured surface from the tool.

Although the die 28 and tool 24 are depicted in a vertical arrangement with respect to one another, horizontal or other arrangements may also be employed. Regardless of the particular arrangement, the die 28 provides the molten resin to the tool 24 at the gap 33.

The die 28 is mounted in a manner that permits it to be moved toward the tool 24. This allows one to adjust the gap 33 to a desired spacing. The size of the gap 33 is a factor of the composition of the molten resin, the desired body thickness, its viscosity, its viscoelastic responses, and the pressure necessary to essentially completely fill the tool with the molten resin as will be understood by those in the art.

The molten resin is of a viscosity such that it preferably substantially fills, optionally with applied vacuum, pressure, temperature, ultrasonic vibration or mechanical means into the cavities of the tool 24. When the resin substantially fills the cavities of the tool 24, the resulting structured surface of the film is said to be replicated.

The negative surface of the tool can be positioned to create features across the width of the film (i.e., in the transverse (TD) direction) or along the length of the film (i.e., along the machine (MD) direction). Perfect alignment with the TD or MD direction is not required. Thus the tool may be slightly off angle from perfect alignment. Typically, this alignment is no more than about 20°.

In the case that the resin is a thermoplastic resin, it is typically supplied as a solid to the feed hopper 32. Sufficient energy is provided to the extruder 30 to convert the solid resin to a molten mass. The tool is typically heated by passing it over a heated drive roll 26A. Drive roll 26A may be heated by, for example circulating hot oil through it or by inductively heating it. The temperature of the tool 24 is typically from 20° C. below the softening point of the resin to the decomposition temperature of the resin.

In the case of a polymerizable resin, including a partially polymerized resin, the resin may be poured or pumped directly into a dispenser that feeds the die 28. If the resin is a reactive resin, the method of the invention may include one or more additional steps of curing the resin. For example, the resin may be cured by exposure to a suitable radiant energy source such as actinic radiation such as ultraviolet light, infrared radiation, electron beam radiation, visible light, etc., for a time sufficient to harden the resin and remove it from the tool 24.

The molten film can be cooled by a variety of methods to harden the film for further processing. These methods include spraying water onto the extruded resin, contacting the unstructured surface of the tool with cooling rolls, or direct impingement of the film with air.

The previous discussion was focused on the simultaneous formation of the film and the structured surface. Another technique useful in the invention comprises contacting a tool to the first surface of a preformed film. Pressure, heat or pressure and heat are then applied to the film/tool combination until the desired structured surface is created in the film. Subsequently, the film is cooled and removed from the tool.

In yet another technique, a preformed film may be machined, such as by diamond turning, to create a desired structured surface thereon.

When a tool is used to create the structured surface, release agents may be used to facilitate removal of the structured surface film from the tool. The release agents may be a material applied as a thin layer to either the surface of the tool or the surface of the film. Alternatively, they may comprise an additive incorporated into the polymer.

A wide variety of materials may be used as the release agent. One class of useful materials comprises organic materials such as oils and waxes and silicones, and polymeric release coatings such as those made from polytetrafluoroethylenes. Another class of release agents that is especially useful comprises fluorochemical benzotriazoles. These materials not only have been found to chemically bond to metal and metalloid surfaces, they also provide, for example, release and/or corrosion inhibiting characteristics to those surfaces. These compounds are characterized as having a head group that can bond to a metallic or metalloid surface (such as a tool) and a tail portion that is suitably different in polarity and/or functionality from a material to be released. These compounds form durable, self-assembled films that are monolayers or substantially monolayers. The fluorochemical benzotriazoles include those having the formula: 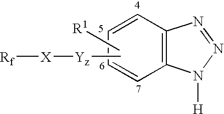
wherein R_{f} is Cₙ F₂ₙ₊₁—(CH₂)ₘ—, wherein n is an integer from 1 to 22 and m is 0, or an integer from 1 to 6; X is —CO₂—, —SO₃—, —CONH—, —O—, —S—, a covalent bond, —SO2NR—, or —NR—, wherein R is H or C₁ to C₅ alkylene; Y is —CH₂— wherein z is 0 or 1; and R′ is H, lower alkyl or R_{f}—X—Y_{z}— with the provisos that when X is —S—, or —O—, m is 0, and z is 0, n is ≧7 and when X is a covalent bond, m or z is at least 1. Preferably n+m is equal to an integer from 8 to 20.

A particularly useful class of fluorochemical benzotriazole compositions for use as release agents comprising one or more compounds having the formula: 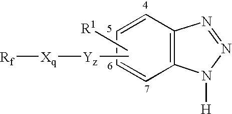
wherein R_{f} is Cₙ F₂ₙ₊₁—(CH₂)ₘ—, wherein n is 1 to 22, m is 0 or an integer from 1 to 6; X is —CO₂—, —SO₃—, —S—, —O—, —CONH—, a covalent bond, —SO₂NR—, or —NR—, wherein R is H or C₁ to C₅ alkylene, and q is 0 or 1; Y is C₁-C₄ alkylene, and z is 0 or 1; and R′ is H, lower alkyl, or R_{f}—X—Y_{z}. Fluorochemical benzotriazotes are described, for example, in U.S. Pat. No. 6,376,065

The process may optionally include a preconditioning step prior to stretching such as providing an oven or other apparatus. The preconditioning step may include a preheating zone and a heat soak zone. The stretch ratios may also be reduced from its maximum to control shrinkage. This is known in the art as “toe in”.

The process may also include a post conditioning step. For example, the film may be first heat set and subsequently quenched.

Uniaxial stretching can occur in a conventional tenter or in a length orienter. A general discussion of film processing techniques can be found in “Film Processing”, edited by Toshitaka Kanai and Gregory Campbell, 1999, Chapters 1, 2, 3, and 6. See also “The Science and Technology of Polymer Films,” edited by Orville J. Sweeting, 1968, Vol. 1, pages 365-391 and 471-429. Uniaxial stretching can also be achieved in a variety of batch devices such as between the jaws of a tensile tester.

Uniaxial stretching processes include, but are not limited to, conventional “length orientation” between rollers rotating at different speeds, conventional cross-web stretching in a tenter, stretching in a parabolic-path tenter such as that disclosed in WO WO 2002/096622 A1, and stretching between the jaws of a tensile tester.

For an ideal elastic material, uniaxial orientation will result if two of three mutually orthogonal stretch ratios are identical. For a material which undergoes no significant change in density upon stretching, each of the two substantially identical stretch ratios will be substantially equal to the square root of the reciprocal of the third orthogonal stretch ratio.

Films stretched in a conventional tenter, although uniaxially oriented, are not truly uniaxially oriented even though they have been uniaxially stretched, because the film is not free to contract along the axis of the direction of travel through the tenter, but is free to contract in the thickness direction. Films stretched in parabolic-path tenters, such as those disclosed in WO 2002/096622 A1, are both uniaxially stretched and truly uniaxially oriented, because the parabolic path allows for an appropriate amount of contraction of the film along the axis of travel through the tenter. Processes other than parabolic-path tentering may also provide true uniaxial orientation, and the concept is not meant to be limited by the process employed.

True uniaxial orientation is also not limited to those processes that stretch film under uniaxial conditions throughout the entire history of the stretch. Preferably, deviation from a uniaxial stretch is maintained within certain tolerances throughout the various portions of the stretching step. However, processes in which deviations from uniaxiality early in a stretching process are compensated for later in the stretching process, and which yield true uniaxiality in the resulting film are also included in the scope of the invention.

Herein, the path traveled by the gripping means of the tenter stretching apparatus which grips a film edge, and hence, the path traced by an edge of the film as it travels through the tenter, is referred to as a boundary trajectory. It is within the present invention to provide a boundary trajectory that is three dimensional and substantially non-planar. The film may be stretched out-of-plane using out-of-plane boundary trajectories, that is, boundary trajectories that do not lie in a single Euclidean plane.

Though it is not required for true uniaxiality, in the parabolic-path tenter process, the film is preferably stretched in plane. It is preferred that straight lines stretched along TD, the principal stretch direction, remain substantially straight after stretching. In conventional tenter processing of films, this is typically not the case, and lines so stretched acquire a substantial curvature or “bow”.

The boundary trajectories may be, but do not need to be, symmetrical, forming mirror images through a central plane. This central plane is a plane passing through a vector in the initial direction of film travel and passing through the initial center point between the boundary trajectories, and a vector normal to the surface of the unstretched film being fed to the stretching apparatus.

Like other film stretching processes, parabolic-path tentering benefits from the selection of conditions such that a uniform spatial drawing of the film is maintained throughout the stretching process. Good spatial uniformity of the film may be achieved for many polymeric systems with careful control of the crossweb and downweb thickness distribution of the unstretched film or web and careful control of the temperature distribution across the web throughout the stretch. Many polymeric systems are particularly sensitive to non-uniformities and will stretch in a non-uniform fashion if caliper and temperature uniformity are inadequate. For example, polypropylenes tend to “line stretch” under uniaxial stretching. Certain polyesters, notably polyethylene naphthalate, are also very sensitive.

Whichever stretching technique is employed, stretching should be done substantially parallel to the first in-plane axis when shape retention of the geometric features is desired. It has been found that the more parallel the stretching is to the first in-plane axis, the better the shape retention that is achieved. Good shape retention can be achieved when the deviation from exactly parallel is no more than 20°. Better shape retention is achieved if the deviation is no more than 10° from exactly parallel. Even better shape retention is achieved if the deviation is no more than 5° from parallel.

The parabolic stretching step also can maintain the deviation from a uniaxial stretch within certain tolerances throughout the various portions of the stretching step. Additionally, these conditions can be maintained while deforming a portion of the film out-of-plane in an initial portion of the stretch, but return the film in-plane during a final portion of the stretch.

In a truly uniaxial transverse stretch maintained throughout the entire history of the stretch, the instantaneous machine direction stretch ratio (MDDR) approximately equals the square root of the reciprocal of the transverse direction stretch ratio (TDDR) as corrected for density changes. As discussed above, the film may be stretched out-of-plane using out-of-plane boundary trajectories, i.e. boundary trajectories that do not lie in a single Euclidean plane. There are innumerable, but nevertheless particular, boundary trajectories meeting relational requirements of this embodiment of the present invention, so that a substantially uniaxial stretch history may be maintained using out-of-plane boundary trajectories.

Following stretching, the film may be heat set and quenched if desired.

Referring now to FIG. 7, an unstretched structured surface film 34 has dimensions T, W and L, respectively representing the thickness, width, and length of the film. After the film 34 is stretched by a factor of lambda (λ), the stretched film 35 has the dimensions T′, W′, and L′ respectively representing the stretched thickness, stretched width, and the stretched length of the film. This stretching imparts uniaxial character to the stretched film 35.

The relationship between the stretch ratios along the first in-plane axis, the second in-plane axis and the third axis is an indication of the fiber symmetry, and hence the uniaxial orientation of the stretched film. In the present invention, the film has a minimum stretch ratio along the first in-plane axis of at least 1.1. Preferably the stretch ratio along the first in-plane axis is at least 1.5. In another embodiment of the invention, the stretch ratio is at least 1.7. More preferably it is at least 3. Higher stretch ratios are also useful. For example, a stretch ratio of 3 to 10 or more is useful in the invention.

The stretch ratios along the second in-plane axis and the third axis are typically substantially the same in the present invention. This substantial sameness is most conveniently expressed as the relative ratio of these stretch ratios to one another. If the two stretch ratios are not equal, then the relative ratio is the ratio of the larger stretch ratio along one of these axes to the smaller stretch ratio along the other of the axes. Preferably the relative ratio is less than 1.4. When the two ratios are equal the relative ratio is 1.

In the case of truly uniaxial stretching with a stretch ratio of λ along the first in-plane direction, when the process creates substantially the same proportional dimensional changes in the second in-plane axis and in the thickness direction of the film along the third axis, the thickness and the width will have been reduced by the same proportional dimensional changes. In the present case, this may be approximately represented by KT/λ^{0.5} and KW/λ^{0.5} where K represents a scale factor that accounts for density changes during stretch. In the ideal case, K is 1. When the density decreases during stretching, K is greater than 1. When density increases during stretching, K is less than 1.

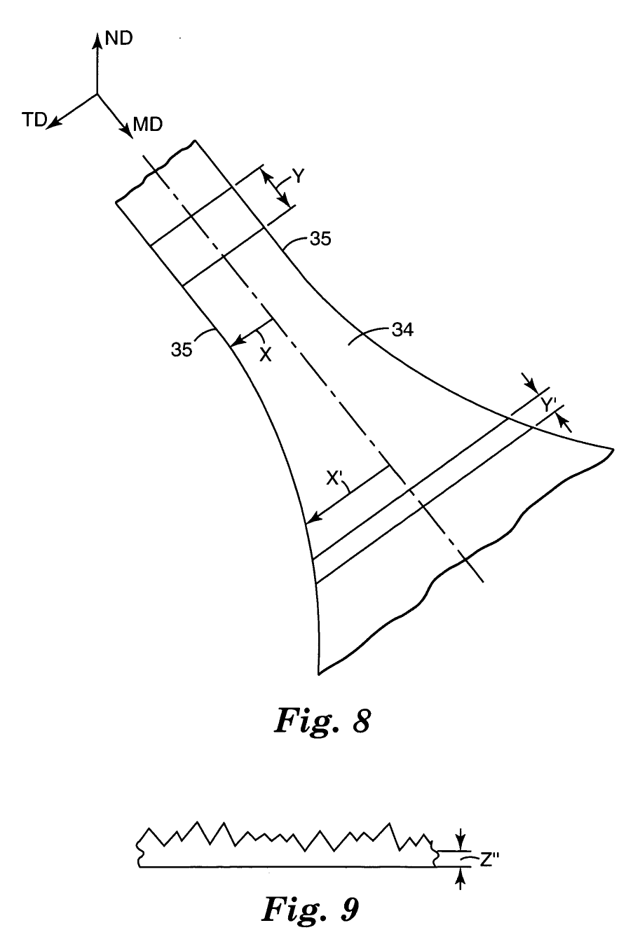

In the invention, the ratio of the final thickness T′ to initial thickness of the film T may be defined as the NDSR stretch ratio (NDSR). The MDSR may be defined as the length of a portion of the film after stretching divided by the initial length of that portion. For illustrative purposes only, see Y′/Y in FIG. 8. The TDSR may be defined as the width of a portion of the film after stretching divided by the initial width of that portion. For illustrative purposes only, see X′/X in FIG. 8.

The first in-plane direction may coincide with the MD, e.g., in the case of a length orientation, or TD, e.g., in the case of a parabolic tenter. In another example, sheets rather than a continuous web are fed into a tenter in the so-called batch tentering process. This process is described in U.S. Pat. No. 6,609,795. In this case the first in-plane direction or axis coincides with TD.

The present invention is applicable generally to a number of different structured surface films, materials and processes where a uniaxial characteristic is desired. The process of the present invention is believed to be particularly suited to fabrication of polymeric films having a microstructured surface where the visco-elastic characteristics of materials used in the film are exploited to control the amount, if any, of molecular orientation induced in the materials when the film is stretched during processing. The improvements include one or more of improved optical performance, enhanced dimensional stability, better processability and the like.

In general, polymers used in the present invention may be crystalline, semi-crystalline, liquid crystalline or amorphous polymers or copolymers. It should be understood that in the polymer art it is generally recognized that polymers are typically not entirely crystalline, and therefore in the context of the present invention, crystalline or semi-crystalline polymers refer to those polymers that are not amorphous and includes any of those materials commonly referred to as crystalline, partially crystalline, semi-crystalline, etc. Liquid crystalline polymers, sometimes also referred to as rigid-rod polymers, are understood in the art to possess some form of long-range ordering which differs from three-dimensional crystalline order.

The present invention contemplates that any polymer either melt-processable or curable into film form may be used. These may include, but are not limited to, homopolymers, copolymers, and oligomers that can be further processed into polymers from the following families: polyesters (e.g., polyalkylene terephthalates (e.g., polyethylene terephthalate, polybutylene terephthalate, and poly-1,4-cyclohexanedimethylene terephthalate), polyethylene bibenzoate, polyalkylene naphthalates (e.g. polyethylene naphthalate (PEN) and isomers thereof (e.g., 2,6-, 1,4-, 1,5-, 2,7-, and 2,3-PEN)) and polybutylene naphthalate (PBN) and isomers thereof), and liquid crystalline polyesters); polyarylates; polycarbonates (e.g., the polycarbonate of bisphenol A); polyamides (e.g. polyamide 6, polyamide 11, polyamide 12, polyamide 46, polyamide 66, polyamide 69, polyamide 610, and polyamide 612, aromatic polyamides and polyphthalamides); polyether-amides; polyamide-imides; polyimides (e.g., thermoplastic polyimides and polyacrylic imides); polyetherimides; polyolefins or polyalkylene polymers (e.g., polyethylenes, polypropylenes, polybutylenes, polyisobutylene, and poly(4- methyl)pentene); ionomers such as Surlyn™ (available from E. I. du Pont de Nemours & Co., Wilmington, Del.); polyvinylacetate; polyvinyl alcohol and ethylene-vinyl alcohol copolymers; polymethacrylates (e.g., polyisobutyl methacrylate, polypropylmethacrylate, polyethylmethacrylate, and polymethylmethacrylate); polyacrylates (e.g., polymethyl acrylate, polyethyl acrylate, and polybutyl acrylate); polyacrylonitrile; fluoropolymers (e.g., perfluoroalkoxy resins, polytetrafluoroethylene, polytrifluoroethylene, fluorinated ethylene-propylene copolymers, polyvinylidene fluoride, polyvinyl fluoride, polychlorotrifluoroethylene, polyethylene-co-trifluoroethylene, poly (ethylene-alt-chlorotrifluoroethylene), and THV™ (3M Co.)); chlorinated polymers (e.g., polyvinylidene chloride and polyvinylchloride); polyarylether ketones (e.g., polyetheretherketone (“PEEK”)); aliphatic polyketones (e.g., the copolymers and terpolymers of ethylene and/or propylene with carbon dioxide); polystyrenes of any tacticity (e.g., atactic polystyrene, isotactic polystyrene and syndiotactic polystyrene) and ring- or chain-substituted polystyrenes of any tacticity (e.g., syndiotactic poly-alpha-methyl styrene, and syndiotactic polydichlorostyrene); copolymers and blends of any of these styrenics (e.g., styrene-butadiene copolymers, styrene-acrylonitrile copolymers, and acrylonitrile-butadiene-styrene terpolymers); vinyl naphthalenes; polyethers (e.g., polyphenylene oxide, poly(dimethylphenylene oxide), polyethylene oxide and polyoxymethylene); cellulosics (e.g., ethyl cellulose, cellulose acetate, cellulose propionate, cellulose acetate butyrate, and cellulose nitrate); sulfur-containing polymers (e.g., polyphenylene sulfide, polysulfones, polyarylsulfones, and polyethersulfones); silicone resins; epoxy resins; elastomers (e.g., polybutadiene, polyisoprene, and neoprene), and polyurethanes. Blends or alloys of two or more polymers or copolymers may also be used.

In some embodiments a semicrystalline thermoplastic may be used. One example of a semicrystalline thermoplastic is a semicrystalline polyester. Examples of semicrystalline polyesters include polyethylene terephthalate or polyethylene naphthalate. Polymers comprising polyethylene terephthalate or polyethylene naphthalate are found to have many desirable properties in the present invention.

Suitable monomers and comonomers for use in polyesters may be of the diol or dicarboxylic acid or ester type. Dicarboxylic acid comonomers include but are not limited to terephthalic acid, isophthalic acid, phthalic acid, all isomeric naphthalenedicarboxylic acids (2,6-, 1,2-, 1,3-, 1,4-, 1,5-, 1,6-, 1,7-, 1,8-, 2,3-, 2,4-, 2,5-, 2,8-), bibenzoic acids such as 4,4′-biphenyl dicarboxylic acid and its isomers, trans-4,4′-stilbene dicarboxylic acid and its isomers, 4,4′-diphenyl ether dicarboxylic acid and its isomers, 4,4′-diphenylsulfone dicarboxylic acid and its isomers, 4,4′-benzophenone dicarboxylic acid and its isomers, halogenated aromatic dicarboxylic acids such as 2-chloroterephthalic acid and 2,5-dichloroterephthalic acid, other substituted aromatic dicarboxylic acids such as tertiary butyl isophthalic acid and sodium sulfonated isophthalic acid, cycloalkane dicarboxylic acids such as 1,4-cyclohexanedicarboxylic acid and its isomers and 2,6-decahydronaphthalene dicarboxylic acid and its isomers, bi- or multi-cyclic dicarboxylic acids (such as the various isomeric norbomane and norbornene dicarboxylic acids, adamantane dicarboxylic acids, and bicyclo-octane dicarboxylic acids), alkane dicarboxylic acids (such as sebacic acid, adipic acid, oxalic acid, malonic acid, succinic acid, glutaric acid, azelaic acid, and dodecane dicarboxylic acid.), and any of the isomeric dicarboxylic acids of the fused-ring aromatic hydrocarbons (such as indene, anthracene, pheneanthrene, benzonaphthene, fluorene and the like). Other aliphatic, aromatic, cycloalkane or cycloalkene dicarboxylic acids may be used. Alternatively, esters of any of these dicarboxylic acid monomers, such as dimethyl terephthalate, may be used in place of or in combination with the dicarboxylic acids themselves.

Suitable diol comonomers include but are not limited to linear or branched alkane diols or glycols (such as ethylene glycol, propanediols such as trimethylene glycol, butanediols such as tetramethylene glycol, pentanediols such as neopentyl glycol, hexanediols, 2,2,4-trimethyl-1,3-pentanediol and higher diols), ether glycols (such as diethylene glycol, triethylene glycol, and polyethylene glycol), chain-ester diols such as 3-hydroxy-2,2-dimethylpropyl-3-hydroxy-2,2-dimethylpropyl-3-hydroxy-2,2-di methyl propanoate, cycloalkane glycols such as 1,4-cyclohexanedimethanol and its isomers and 1,4-cyclohexanediol and its isomers, bi- or multicyclic diols (such as the various isomeric tricyclodecane dimethanols, norbomane dimethanols, norbomene dimethanols, and bicyclo-octane dimethanols), aromatic glycols (such as 1,4-benzenedimethanol and its isomers, 1,4-benzenediol and its isomers, bisphenols such as bisphenol A, 2,2′-dihydroxy biphenyl and its isomers, 4,4′-dihydroxymethyl biphenyl and its isomers, and 1,3-bis(2-hydroxyethoxy)benzene and its isomers), and lower alkyl ethers or diethers of these diols, such as dimethyl or diethyl diols. Other aliphatic, aromatic, cycloalkyl and cycloalkenyl diols may be used.

Tri- or polyfunctional comonomers, which can serve to impart a branched structure to the polyester molecules, can also be used. They may be of either the carboxylic acid, ester, hydroxy or ether types. Examples include, but are not limited to, trimellitic acid and its esters, trimethylol propane, and pentaerythritol.

Also suitable as comonomers are monomers of mixed functionality, including hydroxycarboxylic acids such as parahydroxybenzoic acid and 6-hydroxy-2-naphthalenecarboxylic acid, and their isomers, and tri- or polyfunctional comonomers of mixed functionality such as 5-hydroxyisophthalic acid and the like.

Suitable polyester copolymers include copolymers of PEN (e.g., copolymers of 2,6-, 1,4-, 1,5-, 2,7-, and/or 2,3-naphthalene dicarboxylic acid, or esters thereof, with (a) terephthalic acid, or esters thereof; (b) isophthalic acid, or esters thereof; (c) phthalic acid, or esters thereof; (d) alkane glycols; (e) cycloalkane glycols (e.g., cyclohexane dimethanol diol); (f) alkane dicarboxylic acids; and/or (g) cycloalkane dicarboxylic acids (e.g., cyclohexane dicarboxylic acid)), and copolymers of polyalkylene terephthalates (copolymers of terephthalic acid, or esters thereof, with (a) naphthalene dicarboxylic acid, or esters thereof; (b) isophthalic acid, or esters thereof; (c) phthalic acid, or esters thereof; (d) alkane glycols; (e) cycloalkane glycols (e.g., cyclohexane dimethane diol); (f) alkane dicarboxylic acids; and/or (g) cycloalkane dicarboxylic acids (e.g., cyclohexane dicarboxylic acid)). The copolyesters described may also be a blend of pellets where at least one component is a polymer based on one polyester and other component or components are other polyesters or polycarbonates, either homopolymers or copolymers.

The film of the invention may also contain a disperse phase comprising polymeric particles in a continuous polymeric matrix or a bi-continuous matrix of phases. In an alternative, embodiment of the invention, the disperse phase may be present in one or more of the layers of a multilayer film. The level of polymeric particles used is not critical to the present invention and is selected so as to achieve the purposes for which the final article is intended. Factors which may affect the level and type of the polymer particles include the aspect ratio of the particles, the dimensional alignment of the particles in the matrix, the volume fraction of the particles, the thickness of the structured surface film, etc. Typically, the polymer particles are chosen from the same polymers described above.

Films made in accordance with the present invention may be useful for a wide variety of products including tire cordage, filtration media, tape backings, wipes such as skin wipes, microfluidic films, blur filters, polarizers, reflective polarizers, dichroic polarizers, aligned reflective/dichroic polarizers, absorbing polarizers, retarders (including z-axis retarders), diffraction gratings, polarizing beam splitters and polarizing diffraction gratings. The films may comprise the particular element itself or they can be used as a component in another element such as a tire, a filter, an adhesive tape, beamsplitters e.g., for front and rear projection systems, or as a brightness enhancement film used in a display or microdisplay.

In the above description, the position of elements has sometimes been described in terms of “first”, “second”, “third”, “top” and “bottom”. These terms have been used merely to simplify the description of the various elements of the invention, such as those illustrated in the drawings. They should not be understood to place any limitations on the useful orientation of the elements of the present invention.

Accordingly, the present invention should not be considered limited to the particular examples described above, but rather should be understood to cover all aspects of the invention as fairly set out in the claims. Various modifications, equivalents, as well as numerous structures to which the present invention may be applicable will be readily apparent to those of skill in the art to which the present invention is directed upon review of the present specification. The claims are intended to cover such modifications and devices.

### EXAMPLES

### Example 1

A polyethylene terephthalate (PET) with an inherent viscosity (I.V.) of 0.74 available from Eastman Chemical Company, Kingsport, Tenn. was used in this example.

The PET pellets were dried to remove residual water and loaded into the extrusion of an extruder hopper under a nitrogen purge. The PET was extruded with a increasing temperature profile of 232° C. to 282° C. within the extruder and the continuing melt train through to the die set at 282° C. Melt train pressures were continuously monitored and an average taken at the final monitored position along the melt train prior to bringing the die into close proximity to the tool onto which the polymer film is formed simultaneously with the structuring of a first surface of that film against the tool.

The tool was a structured belt having a negative version of the structured surface formed on the cast film. The structured surface comprised a repeating and continuous series of triangular prisms. The triangles formed a sawtooth-like pattern. The basal vertices of the individual prisms were shared by their adjoining, neighboring structures. The prisms were aligned along the casting or machine direction (MD) direction. The structured surface of the tool was coated with a fluorochemical benotriazole having the formula 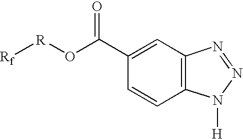
where R_{f} is CgF₁₇ and R is —(CH₂)₂—, as disclosed in U.S. Pat. No. 6,376,065. The tool was mounted on a temperature-controlled rotating can which provides a continuous motion of the tool surface along the casting (MD) direction. The measured surface temperature of the tool averaged 92° C.

The die orifice through which the molten polymer exits the melt train was brought into close proximity with the rotating belt tool forming a final slot between the tool and die. The pressure at the final monitored position along the melt train increased as the die and tool became closer. The difference between this final pressure and the previously recorded pressure is referred to as the slot pressure drop. The slot pressure drop in this example was 7.37×10⁶ Pa (1070 psi) providing sufficient pressure to drive the molten polymer into the structured cavities formed by the tool negative. The film thereby formed and structured, was conveyed by the tool rotation from the slot, quenched with additional air cooling, stripped from the tool and wound into a roll. Including the height of the structures, the total thickness of the cast film (T) was about 510 microns.

The cast and wound polymer film closely replicated the tool structure. Using a microscope to view the cross-section a prismatic structure was identified on the surface of the film with an approximately 85° apex angle, 20° inclination from the horizontal of the film land for one leg of the triangle and a 15° tilt from the perpendicular for the opposite leg. The measured profile exhibited the expected, nearly right triangular form with straight edges and a slightly rounded apex. The replicated prisms on the polymeric film surface were measured to have a basal width (BW) of 44 microns and a height (P) of 19 microns. The peak-to-peak spacing (PS) was approximately the same as the basal width (BW). The tool is also imperfect and small deviations from nominal sizing can exist.

The structured cast film was cut into sheets with an aspect ratio of 10:7 (along the grooves:perpendicular to grooves), preheated to about 100° C. as measured in the plenums and stretched to a nominal stretch ratio of 6.4 and immediately relaxed to a stretch ratio of 6.3 in a nearly truly uniaxial manner along the continuous length direction of the prisms using a batch tenter process. That is individual sheets were fed to a conventional continuous operation film tenter. The relaxation from 6.4 to 6.3 is accomplished at the stretch temperature to control shrinkage in the final film. The structured surfaces maintained a prismatic shape with reasonably straight cross-sectional edges (reasonably flat facets) and approximately similar shape. The basal width after stretch (BW′) was measured by microscopy cross-sectioning to be 16.5 microns and the peak height-after stretch (P′) was measured to be 5.0 microns. The final thickness of the film (T′), including the structured height, was measured to be 180 microns. The indices of refraction were measured on the backside of the stretched film using a Metricon Prism Coupler as available from Metricon, Piscataway, N.J., at a wavelength of 632.8 nm. The indices along the first in-plane (along the prisms), second in-plane (across the prisms) and in the thickness direction were measured to be 1.672, 1.549 and 1.547 respectively. The relative birefringence in the cross-sectional plane of this stretched material was thus 0.016.

### Example 2

A polyethylene terephthalate (PET) with an inherent viscosity (I.V.) of 0.74 available from Eastman Chemical Company, Kingsport, Tenn. was used in this example.

The PET pellets were dried to remove residual water and loaded into the extrusion hopper under a nitrogen purge. The PET was extruded with a flat temperature profile about 282° C. within the extruder and the continuing melt train through to the die set at 282° C. Melt train pressures were continuously monitored and an average taken at the final monitored position along the melt train prior to bringing the die into close proximity to the tool onto which the polymer film is formed simultaneously with the structuring of a first surface of that film against the tool.

The tool was a structured belt having the desired negative version of the structured surface formed on the cast film. The structured surface comprised a repeating and continuous series of isosceles right triangular prisms, with basal widths (BW) of 50 microns and height (P) of nearly 25 microns. The basal vertices of the individual prisms were shared by their adjoining, neighboring structures. The prisms were aligned along the casting (MD) direction. The structured surface of the tool was coated with a fluorochemical benezotriazole having the formula 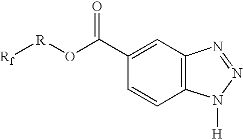
where R_{f} is C₄F₉ and R is —(CH₂)₆—. The tool was mounted on a temperature-controlled rotating can which provides a continuous motion of the tool surface along the casting (MD) direction. The measured surface temperature of the tool averaged 98° C.

The die orifice through which the molten polymer exits the melt train was brought into close proximity with the rotating belt tool forming a final slot between the tool and die. The pressure at the final monitored position along the melt train increased as the die and tool became closer. The difference between this final pressure and the previously recorded pressure is referred to as the slot pressure drop. The slot pressure drop in this example was 7.92×10⁶ Pa (1150 psi) providing sufficient pressure to drive the molten polymer into the structured cavities formed by the tool negative. The film thereby formed and structured, was conveyed by the tool rotation from the slot, quenched with additional air cooling, stripped from the tool and wound into a roll. Including the height of the structures, the total thickness of the cast film (T) was about 600 microns.

The cast and wound polymer film closely replicated the tool structure. Using contact profilometry, (e.g. a KLA-Tencor P-10 with a 60° 2 micron radius stylus).a clear, reasonably sharp prismatic structure was identified on the surface of the film. The measured profile exhibited the expected, nearly right triangular form with straight edges and a slightly rounded apex. The replicated prisms on the polymeric film surface were measured to have a basal width (BW) of 50 microns and a height (P) of 23.4 microns. The peak-to-peak spacing (PS) was approximately the same as the basal width (BW). The profilometry is limited to about a micron in resolution due to the shape and size of the stylus probe and the actual apex may be considerably higher. The tool is also imperfect and small deviations from nominal sizing can exist. A ratio of the profile-measured cross-sectional area to the ideal calculated cross-sectional area provided a calculated fill of 99%.

The structured film can be stretched in a manner similar to that in Example 1.

### Example 3

A polyethylene naphthalate (PEN) with an inherent viscosity (I.V.) of 0.56 was made in a reactor vessel.

The PEN pellets were dried to remove residual water and loaded into the extrusion hopper under a nitrogen purge. The PEN was extruded with a flat temperature profile of 288° C. within the extruder and the continuing melt train through to the die set at 288° C. Melt train pressures were continuously monitored and an average taken at the final monitored position along the melt train prior to bringing the die into close proximity to the tool onto which the polymer film is formed simultaneously with the structuring of a first surface of that film against the tool.

The tool was a structured belt having the desired negative version of the structured surface formed on the cast film. The structured surface comprised a repeating and continuous series of isosceles right triangular prisms, with basal widths (BW) of 50 microns and height (P) of nearly 25 microns. The basal vertices of the individual prisms were shared by their adjoining, neighboring structures. The prisms were aligned along the casting (MD) direction. The structured surface of the tool was coated with a fluorochemical benzotriazole having the formula 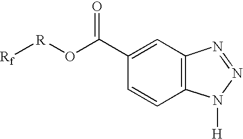
where R_{f} is C₈F₁₇ and R is —(CH₂)₂—. The tool was mounted on a temperature-controlled rotating can which provides a continuous motion of the tool surface along the casting (MD) direction. The measured surface temperature of the tool averaged 144° C.

The die orifice through which the molten polymer exits the melt train was brought into close proximity with the rotating belt tool forming a final slot between the tool and die. The pressure at the final monitored position along the melt train increased as the die and tool became closer. The difference between this final pressure and the previously recorded pressure is referred to as the slot pressure drop. The slot pressure drop in this example was 5.5×10⁶ Pa (800 psi) providing sufficient pressure to drive the molten polymer into the structured cavities formed by the tool negative. The film thereby formed and structured, was conveyed by the tool rotation from the slot, quenched with additional air cooling, stripped from the tool and wound into a roll. Including the height of the structures, the total thickness of the cast film (T) was about 600 microns.

The cast and wound polymer film closely replicated the tool structure. Using contact profilometry, (e.g. a KLA-Tencor P-10 with a 60° 2 micron radius stylus). A clear, reasonably sharp prismatic structure was identified on the surface of the film. The measured profile exhibited the expected, nearly right triangular form with straight edges and a slightly rounded apex. The replicated prisms on the polymeric film surface were measured to have a basal width (BW) of 50 microns and a height (P) of 23.3 microns. The peak-to-peak spacing (PS) was approximately the same as the basal width (BW). The profilometry is limited to about a micron in resolution due to the shape and size of the stylus probe and the actual apex may be considerably higher. The tool is also imperfect and small deviations from nominal sizing can exist. To better characterize the actual extent of fill, e.g. characterize the precision of replication with the tool, the profilometry cross-section was fit to a triangle. Using data from the measured profile, the edges were fit as straight lines along the legs of the cross-section between 5 and 15 micron height as measured from the base. An ideal apex height of 24.6 microns was calculated. A ratio of the profile-measured cross-sectional area to the ideal calculated cross-sectional area provided a calculated fill of 98.0%.

The structured cast film was stretched in a nearly truly uniaxial manner along the continuous length direction of the prisms, using a batch tenter process. The film was preheated to nominally 165° C. as measured in the plenums and stretched at this temperature over 25 seconds at a uniform speed (edge separation) to a final stretch ratio of about 6. The structured surfaces maintained a prismatic shape with reasonably straight cross-sectional edges (reasonably flat facets) and approximately similar shape.

Table 1 shows the effect of stretching at various distances from the center of the cast film.

| | | | Ratio of | | | | | | | |
|---|---|---|---|---|---|---|---|---|---|---|
| | | | higher to | | | | In-plane | In-plane | Refractive | |
| Relative | Nominal | Thick. | lower cross | Thickness | Peak Height | Peak width | refractive | refractive | index | Relative |
| Distance | Length | Stretch | sectional | (T′) | (P′) | (BW′) | index along | index perp. | through | Birefrin- |
| from Center | Stretch Ratio | Ratio | stretch ratios | microns | Microns | Microns | stretch | to stretch | thickness | gence |
| 0.000 | 0.427 | 0.381 | 1.12 | 230 | 8.4127 | 22.025 | 1.8095 | 1.5869 | 1.5785 | 0.0370 |
| 0.044 | 0.427 | 0.385 | 1.11 | 230 | 8.4494 | 21.95385 | 1.81 | 1.5873 | 1.5781 | 0.0405 |
| 0.089 | 0.427 | 0.377 | 1.13 | 230 | 8.4226 | 22.08462 | 1.8101 | 1.5869 | 1.5779 | 0.0395 |
| 0.133 | 0.427 | 0.414 | 1.03 | 250 | 8.3739 | 22.16154 | 1.8101 | 1.5871 | 1.5778 | 0.0409 |
| 0.178 | 0.427 | 0.385 | 1.11 | 230 | 8.3923 | 22.05 | 1.8104 | 1.5866 | 1.5781 | 0.0373 |
| 0.222 | 0.422 | 0.377 | 1.12 | 230 | 8.3194 | 21.9286 | 1.8132 | 1.5859 | 1.5799 | 0.0261 |
| 0.267 | 0.417 | 0.368 | 1.13 | 220 | 8.1205 | 21.85 | 1.8153 | 1.5859 | 1.5778 | 0.0347 |
| 0.311 | 0.417 | 0.352 | 1.18 | 210 | 7.8141 | 21.9143 | 1.8166 | 1.5859 | 1.5752 | 0.0453 |
| 0.356 | 0.411 | 0.335 | 1.23 | 200 | 7.4737 | 21.9615 | 1.818 | 1.5875 | 1.5744 | 0.0553 |
| 0.400 | 0.406 | 0.322 | 1.26 | 190 | 7.1668 | 22.1071 | 1.8173 | 1.5887 | 1.572 | 0.0705 |
| 0.444 | 0.406 | 0.31 | 1.31 | 190 | 6.8934 | 22.5143 | 1.8166 | 1.5908 | 1.5727 | 0.0771 |
| 0.489 | 0.411 | 0.301 | 1.37 | 180 | 6.6182 | 22.85 | 1.8161 | 1.5917 | 1.5718 | 0.0849 |
| 0.533 | 0.417 | 0.289 | 1.44 | 170 | 6.3933 | 23.4154 | 1.8146 | 1.5924 | 1.5714 | 0.0902 |
| 0.578 | 0.422 | 0.272 | 1.55 | 160 | 5.8504 | 24.2167 | 1.8163 | 1.5979 | 1.5686 | 0.1257 |
| 0.622 | 0.438 | 0.264 | 1.66 | 160 | 5.6835 | 25.3154 | 1.8131 | 1.5988 | 1.5662 | 0.1414 |
| 0.667 | 0.458 | 0.264 | 1.73 | 160 | 5.6538 | 26.8769 | 1.8112 | 1.6014 | 1.5643 | 0.1625 |
| 0.711 | 0.484 | 0.26 | 1.86 | 160 | 5.6149 | 28.725 | 1.8111 | 1.6112 | 1.5615 | 0.2211 |
| 0.756 | 0.51 | 0.251 | 2.03 | 150 | 5.5633 | 30.8818 | 1.811 | 1.6089 | 1.5579 | 0.2241 |
| 0.800 | 0.552 | 0.247 | 2.23 | 150 | 5.4791 | 33.77 | 1.8117 | 1.6128 | 1.552 | 0.2652 |
| 0.844 | 0.594 | 0.243 | 2.44 | 150 | 5.6443 | 36.075 | 1.8143 | 1.6164 | 1.5454 | 0.3042 |

Relative distance from center = distance from center/one half of the width of the film

### Example 4

A polyethylene naphthalate (PEN) with an inherent viscosity (I.V.) of 0.56 was made in a reactor vessel.

The PEN pellets were dried to remove residual water and loaded into the extrusion hopper under a nitrogen purge. The PEN was extruded with a flat temperature profile of 288° C. within the extruder and the continuing melt train through to the die set at 288° C. Melt train pressures were continuously monitored and an average taken at the final monitored position along the melt train prior to bringing the die into close proximity to the tool onto which the polymer film is formed simultaneously with the structuring of a first surface of that film against the tool.

The tool was a structured belt having the desired negative version of the structured surface formed on the cast film. The structured surface comprised a repeating and continuous series of isosceles right triangular prisms, with basal widths (BW) of 50 microns and height (P) of nearly 25 microns. The basal vertices of the individual prisms were shared by their adjoining, neighboring structures. The prisms were aligned along the casting (MD) direction. The structured surface of the tool was coated with a fluorochemical benzotriazole having the formula 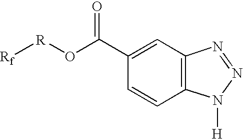
where R_{f} is C₈F₁₇ and R is —(CH₂)₂—, as disclosed in U.S. Pat. No. 6,376,065. The tool was mounted on a temperature-controlled rotating can which provides a continuous motion of the tool surface along the casting (MD) direction. The measured surface temperature of the tool averaged 153° C.

The die orifice through which the molten polymer exits the melt train was brought into close proximity with the rotating belt tool forming a final slot between the tool and die. The pressure at the final monitored position along the melt train increased as the die and tool became closer. The difference between this final pressure and the previously recorded pressure is referred to as the slot pressure drop. The slot pressure drop in this example was 4.13×10⁶ Pa (600 psi) providing sufficient pressure to drive the molten polymer into the structured cavities formed by the tool negative. The film thereby formed and structured, was conveyed by the tool rotation from the slot, quenched with additional air cooling, stripped from the tool and wound into a roll. Including the height of the structures, the total thickness of the cast film (T) was about 600 microns.

The cast and wound polymer film closely replicated the tool structure. Using contact profilometry, (e.g. a KLA-Tencor P-10 with a 60° 2 micron radius stylus).a clear, reasonably sharp prismatic structure was identified on the surface of the film. The measured profile exhibited the expected, nearly right triangular form with straight edges and a slightly rounded apex. The replicated prisms on the polymeric film surface were measured to have a basal width (BW) of microns and a height (P) of 23.5 microns. The peak-to-peak spacing (PS) was approximately the same as the basal width (BW). The profilometry is limited to about a micron in resolution due to the shape and size of the stylus probe and the actual apex may be considerably higher. The tool is also imperfect and small deviations from nominal sizing can exist. To better characterize the actual extent of fill, e.g. characterize the precision of replication with the tool, the profilometry cross-section was fit to a triangle. Using data from the measured profile, the edges were fit as straight lines along the legs of the cross-section between 5 and 15 micron height as measured from the base. An ideal apex height of 24.6 microns with an included apex angle of 91.1° was calculated. A ratio of the profile-measured cross-sectional area to the ideal calculated cross-sectional area provided a calculated fill of 98.0%.

The structured cast film was stretched in a nearly truly uniaxial manner along the continuous length direction of the prisms using the batch tenter process. The film was preheated to nominally 158° C. for stretched at this temperature over 90 seconds at a uniform speed (edge separation) to a final stretch ratio of about 6. The structured surfaces maintained a prismatic shape with reasonably straight cross-sectional edges (reasonably flat facets) and approximately similar shape.

The same contact profilometry as used on the cast film was used to measure the stretched film. The basal width after stretch (BW′) was measured by microscopy cross-sectioning to be 22 microns and the peak height after stretch (P′) was measured to be 8.5 microns. The final thickness of the film (T′), including the structured height, was calculated to be about 220 microns. The indices of refraction were measured on the backside of the stretched film using a Metricon Prism Coupler as available from Metricon, Piscataway, N.J., at a wavelength of 632.8 nm. The indices along the first in-plane (along the prisms), second in-plane (across the prisms) and in the thickness direction were measured to be 1.790, 1.577 and 1.554 respectively. The relative birefringence in the cross-sectional plane of this stretched material was thus 0.10.

Using the profilometry data, the ratio of the apparent cross-sectional areas provide a measured estimate of the stretch ratio of 6.4, uncorrected for density changes upon stretching and orientation. Using this value of 6.4 for the stretch ratio and the profilometry data, the shape retention parameter was calculated to be 0.94.

### Example 5

A co-polymer (so-called 40/60 coPEN) comprising 40 mol % polyethylene terephthalate (PET) and 60 mol % polyethylene naphthalate character, as determined by the carboxylate (terephthalate and naphthalate) moiety (sub-unit) ratios, was made in a reactor vessel. The inherent viscosity (I.V.) was about 0.5.

The 40/60 coPEN resin pellets were dried to remove residual water and loaded into the extrusion hopper under a nitrogen purge. The 40/60 coPEN was extruded with a decreasing temperature profile of 285° C. to 277° C. within the extruder and the continuing melt train through to the die set at 288° C. Melt train pressures were continuously monitored and an average taken at the final monitored position along the melt train prior to bringing the die into close proximity to the tool onto which the polymer film is formed simultaneously with the structuring of a first surface of that film against the tool.

The tool was a structured belt having the desired negative version of the structured surface formed on the cast film. The structured surface comprised a repeating and continuous series of isosceles right triangular prisms, with basal widths (BW) of 50 microns and height (P) of nearly 25 microns. The basal vertices of the individual prisms were shared by their adjoining, neighboring structures. The prisms were aligned along the casting (MD) direction. The structured surface of the tool was coated with a fluorochemical benzotriazole having the formula 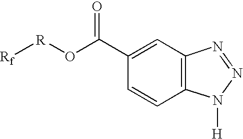
where R_{f} is C₄F₉ and R is —(CH₂)₆—, as disclosed in U.S. Pat. No. 6,376,065. The tool was mounted on a temperature-controlled rotating can which provides a continuous motion of the tool surface along the casting (MD) direction. The measured surface temperature of the tool averaged 102° C.

The die orifice through which the molten polymer exits the melt train was brought into close proximity with the rotating belt tool forming a final slot between the tool and die. The pressure at the final monitored position along the melt train increased as the die and tool became closer. The difference between this final pressure and the previously recorded pressure is referred to as the slot pressure drop. The slot pressure drop in this example was 4.23×10⁶ Pa (614 psi) providing sufficient pressure to drive the molten polymer into the structured cavities formed by the tool negative. The film thereby formed and structured, was conveyed by the tool rotation from the slot, quenched with additional air cooling, stripped from the tool and wound into a roll. Including the height of the structures, the total thickness of the cast film (T) was about 560 microns.

The cast and wound polymer film closely replicated the tool structure. Using contact profilometry, (e.g. a KLA-Tencor P-10 with a 60° 2 micron radius stylus), a clear, reasonably sharp prismatic structure was identified on the surface of the film. The measured profile exhibited the expected, nearly right triangular form with straight edges and a slightly rounded apex. The replicated prisms on the polymeric film surface were measured to have a basal width (BW) of 49.9 microns and a height (P) of 23.5 microns. The peak-to-peak spacing (PS) was approximately the same as the basal width (BW). The profilometry is limited to about a micron in resolution due to the shape and size of the stylus probe and the actual apex may be considerably higher. The tool is also imperfect and small deviations from nominal sizing can exist. To better characterize the actual extent of fill, e.g. characterize the precision of replication with the tool, the profilometry cross-section was fit to a triangle. Using data from the measured profile, the edges were fit as straight lines along the legs of the cross-section between 5 and 15 micron height as measured from the base. An ideal apex height of 24.6 microns with an included apex angle of 91.1° was calculated. A ratio of the profile-measured cross-sectional area to the ideal calculated cross-sectional area provided a calculated fill of 98.0%.

The structured cast film was stretched in a nearly truly uniaxial manner along the continuous length direction of the prisms. Using a laboratory stretcher. The film was preheated to 103° C. for 60 seconds and stretched at this temperature over 20 seconds at a uniform speed (edge separation) to a final stretch ratio of about 6. The structured surfaces maintained a prismatic shape with reasonably straight cross-sectional edges (reasonably flat facets) and approximately similar shape. The indices of refraction were measured on the backside of the stretched film using a Metricon Prism Coupler as available from Metricon, Piscataway, N.J., at a wavelength of 632.8 nm. The indices along the first in-plane (along the prisms), second in-plane (across the prisms) and in the thickness direction were measured to be 1.758, 1.553 and 1.551 respectively. The relative birefringence in the cross-sectional plane of this stretched material was thus 0.0097.

### Example 6

A multilayer optical film made according to the procedures as described in examples 1-4 of U.S. Patent Application Publication 2004/0227994 A1 was cast and the protective polypropylene skin layer removed. The low index polymer used was a co-PET.

The multilayer optical film was cut into a sheet and dried in an oven at 60° C. for a minimum of 2 hours. The platens were heated to 115° C. The film was stacked in a construction of layers in the order: cardboard sheet, chrome plated brass plates (approx 3 mm thick), release liner, nickel microstructured tool, multilayer optical film, release liner, chrome plated brass plate (approx 3 mm thick), and cardboard sheet. The construction was placed between the platens and closed. A pressure of 1.38×10⁵ Pa (20 psi) was maintained for 60 seconds.

The structured surface of the nickel microstructured tool comprised a repeating and continuous series of triangular prisms, with a 90° apex angle, basal widths (BW) of 10 microns and a height (P) of about 5 microns. The basal vertices of the individual prisms were shared by their adjoining, neighboring structures.

The embossed sheets were cut to an aspect ratio of 10:7 (along to across the grooves). The structured multilayer optical film was stretched in a nearly truly uniaxial manner along the continuous length direction of the prisms using a batch tenter process. The film was preheated to nearly 100° C., stretched to a stretch ratio around 6 over about 20 seconds, and then the stretching was reduced by about 10% while still in the tenter at stretch temperature, to control shrinkage in the film. The final thickness of the film (T′), including the structured height, was measured to be 150 microns. The indices of refraction were measured on the backside of the stretched film using a Metricon Prism Coupler as available from Metricon, Piscataway, N.J., at a wavelength of 632.8 nm. The indices along the first in-plane (along the prisms), second in-plane (across the prisms) and in the thickness direction were measured to be 1.699, 1.537 and 1.534 respectively. The birefringence in the cross-sectional plane of this stretched material was thus 0.018.

### Example 7

An oriented, microreplicated structure was constructed as follows: 90° prismatic grooves at 125 micron pitch were embossed into an 0.010 inch thick film of cast PEN(polyether naphalate) by compression molding at 125 C for 4 minutes. The tool structured film was quenched in an icewater. After removal and drying of the film, the film was then uniaxially stretched 5× along the long axis of the grooves at 128 C. This resulted in transverse shrinkage of 5%, yielding a final pitch of approximately 62 microns. The refractive index was measured to be 1.84 along the oriented axis and 1.53 in the transverse direction. The indices of refraction were measured on the flat backside of the film using a Metricon Prism Coupler at a wavelength of 632.8 nm.

A piece of the oriented microstructured film was subsequently adhered to a glass microscope slide with the structured surface facing the slide using a UV curable acrylate resin with an isotropic refractive index 1.593. The acrylate resin was cured by multiple passes through the UV chamber—3 times on each side to ensure full cure of the resin.

A Helium-Neon laser beam was passed through the slide mounted oriented structured film. The HeNe laser was cleaned to a uniform linear polarization by passing through a Glan-Thompson polarizer. The ordinary-ray (o-ray) passed through the structure with only a small degree of splitting, where the half angle of the zeroth order divergence was found to be approximately 2°. A half-wave plate was then inserted immediately after the Glan-Thompson in order to rotate the laser beam 90° to the orthogonal polarization (e-ray). The zeroth order beam showed a divergence half angle of approximately 8°, or 4× the divergence of the o-ray.

What is claimed:

1. A method of making a polymeric film having a desired structured surface comprising the steps of:
(a) providing a tool that comprises a negative surface of the desired structured surface;
(b) contacting the negative surface of the tool with a resin to create the desired structured surface, the desired structured surface comprising a geometric feature;
(c) optionally solidifying the resin to form a film having (i) the desired structured surface and an opposed surface, and (ii) first and second in-plane axes that are orthogonal with respect to each other and a third axis that is mutually orthogonal to the first and second in-plane axis in a thickness direction of the film;
(d) removing the film from the negative surface of the tool; and subsequently
(e) stretching the polymeric film in a direction substantially parallel to the first in-plane axis of the polymeric film.

2. A method according to claim 1 wherein the cross sectional shape of the geometric feature before step (b) is substantially retained after step (b).

3. A method according to claim 1 wherein the molten resin is supplied to a gap between the tool and a second surface.

4. A method according to claim 1 wherein the negative surface of the tool comprises a layer of a release agent.

5. A method according to claim 1 wherein the release agent comprises a monolayer.

6. A method according to claim 1 wherein the release agent comprises a fluorochemical benzotriazole.

7. A method according to claim 1 wherein the polymeric film has a first orientation state prior to stretching and a second orientation state, different than the first orientation state, after orientation.

8. A method of making a desired microstructure surface film, the microstructure surface comprising a plurality of elongate geometric micro-features, the method comprising the steps of:
(a) providing a tool comprising a negative version of the desired microstructure surface;
(b) providing a polymeric resin to a gap formed between the master tool and a second surface;
(c) forming a polymeric film having the desired microstructure surface in the gap, the film having (i) first and second in-plane axes that are mutually orthogonal with respect to each other and a third axes that is mutually orthogonal with respect to the first and second in-plane axes in a thickness direction of the film, and (ii) the desired microstructure surface having the elongate micro-features positioned in a direction substantially parallel to the first in-plane axis;
(d) removing the polymeric film of step (c) from the tool; and
(e) stretching the polymeric film in a direction substantially parallel to the first in-plane axis.

9. A method according to claim 8 wherein the cross sectional shape of the elongate geometric features is substantially retained throughout stretching.

10. A method according to claim 9, wherein the oriented film comprises at least one layer with a first index of refraction (n₁) along the first in-plane axis, a second index of refraction (n₂) along the second in-plane axis, and a third index of refraction (n₃) along the third axis, wherein n₁≠n₂ and n₁≠n₃ and n₂ and n₃ are substantially equal to one another relative to their differences with n₁.
